(19) United States
(12) Patent Application Publication
(10) Pub. No.: US 2025/0070268 A1
(43) Pub. Date: Feb. 27, 2025

(54) SECONDARY BATTERY

(71) Applicant: MURATA MANUFACTURING CO., LTD., Kyoto (JP)

(72) Inventors: Daiki NISHIIE, Kyoto (JP); Moriaki OKUNO, Kyoto (JP)

(21) Appl. No.: 18/944,748

(22) Filed: Nov. 12, 2024

(30) Foreign Application Priority Data
Sep. 8, 2022 (JP) 2022-143250

(51) Int. Cl. H01M 10/0587; H01M 10/0525; H01M 50/109

(52) U.S. Cl. CPC H01M 10/0587; H01M 50/109; H01M 10/0525

(57) ABSTRACT

A secondary battery having higher reliability is provided. The secondary battery includes a battery device and an outer package member. The battery device includes a first electrode and a second electrode that are stacked with a separator interposed between the first electrode and the second electrode, and are wound around a winding axis extending in a first direction. The outer package member contains the battery device. The second electrode includes a second electrode current collector, an inner side second electrode active material layer, and an outer side second electrode active material layer. The second electrode current collector has an inward second electrode surface and an outward second electrode surface. The inward second electrode surface faces a side of the winding axis. The outward second electrode surface is on an opposite side to the inward second electrode surface. The inner side second electrode active material layer is provided on the inward second electrode surface. The outer side second electrode active material layer is provided on the outward second electrode surface. An area density of the outer side second electrode active material layer is higher than an area density of the inner side second electrode active material layer over a region from an inner winding side end part of the battery device to an outer winding side end part of the battery device. The inner side second electrode active material layer is opposed to the outer side second electrode active material layer with the second electrode current collector interposed between the inner side second electrode active material layer and the outer side second electrode active material layer.

The present application is a continuation of International patent application no. PCT/JP2023/024445, filed on Jun. 30, 2023, which claims priority to Japanese patent application no. 2022-143250, filed on Sep. 8, 2022, the entire contents of which are incorporated herein by reference.

### BACKGROUND

The present disclosure relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed and including: an electrode body including a positive electrode body and a negative electrode body that are stacked or wound with a separator interposed therebetween; and an outer package casing containing the electrode body.

### SUMMARY

The present disclosure relates to a secondary battery.

Consideration has been given in various ways to improve performance of a secondary battery. However, there is room for improvement in terms of the performance of the secondary battery.

It is therefore desirable to provide a secondary battery having higher reliability.

A secondary battery according to a first aspect of an embodiment of the present disclosure includes a battery device and an outer package member. The battery device includes a first electrode and a second electrode that are stacked with a separator interposed between the first electrode and the second electrode, and are wound around a winding axis extending in a first direction. The outer package member contains the battery device. The second electrode includes a second electrode current collector, an inner side second electrode active material layer, and an outer side second electrode active material layer. The second electrode current collector has an inward second electrode surface and an outward second electrode surface. The inward second electrode surface faces a side of the winding axis. The outward second electrode surface is on an opposite side to the inward second electrode surface. The inner side second electrode active material layer is provided on the inward second electrode surface. The outer side second electrode active material layer is provided on the outward second electrode surface. An area density of the outer side second electrode active material layer is higher than an area density of the inner side second electrode active material layer over a region from an inner winding side end part of the battery device to an outer winding side end part of the battery device. The inner side second electrode active material layer is opposed to the outer side second electrode active material layer with the second electrode current collector interposed between the inner side second electrode active material layer and the outer side second electrode active material layer.

A secondary battery according to a second aspect of an embodiment of the present disclosure includes a battery device and an outer package member. The battery device includes a first electrode and a second electrode that are stacked with a separator interposed between the first electrode and the second electrode, and are wound around a winding axis extending in a first direction. The outer package member contains the battery device. The second electrode includes a second electrode current collector, an inner side second electrode active material layer, and an outer side second electrode active material layer. The second electrode current collector has an inward second electrode surface and an outward second electrode surface. The inward second electrode surface faces a side of the winding axis. The outward second electrode surface is on an opposite side to the inward second electrode surface. The inner side second electrode active material layer is provided on the inward second electrode surface. The outer side second electrode active material layer is provided on the outward second electrode surface. An area density of the outer side second electrode active material layer is highest at an inner winding side end part of the battery device, and decreases from the inner winding side end part of the battery device toward an outer winding side end part of the battery device. An area density of the inner side second electrode active material layer is lowest at the inner winding side end part of the battery device, and increases from the inner winding side end part of the battery device toward the outer winding side end part of the battery device.

According to the secondary battery of the first aspect of an embodiment of the present disclosure and the secondary battery of the second aspect of an embodiment of the present disclosure, in terms of a relationship between the first electrode and the second electrode that are opposed to each other with the separator interposed therebetween, a capacity of the second electrode is greater than a capacity of the first electrode. It is thus possible to suppress generation of a deposited matter caused by a battery reaction, and to suppress a decrease in battery performance. Accordingly, the secondary battery achieves high reliability.

Note that effects of the present disclosure are not necessarily limited to those described above and may include any of a series of effects described below in relation to the present technology.

### BRIEF DESCRIPTION OF THE FIGURES

FIG. 1 is a perspective diagram illustrating a configuration of a secondary battery according to an embodiment of the present disclosure.

FIG. 2 is a sectional diagram illustrating the configuration of the secondary battery illustrated in FIG. 1.

FIG. 3 is a sectional diagram illustrating a configuration of a battery device illustrated in FIG. 2.

FIG. 4 is a sectional diagram illustrating a configuration example of a sectional structure of the battery device illustrated in FIG. 2.

FIG. 5 is a developed diagram schematically illustrating a positive electrode and a negative electrode of the battery device illustrated in FIG. 2.

FIG. 6 is a perspective diagram illustrating a configuration of an outer package can to be used in a process of manufacturing the secondary battery illustrated in FIG. 1.

FIG. 7 is an explanatory diagram illustrating a relationship between a capacity of the positive electrode and a capacity of the negative electrode in the battery device illustrated in FIG. 2.

FIG. 8 is a developed diagram schematically illustrating a positive electrode and a negative electrode of a battery device of a secondary battery according to an embodiment of the present disclosure.

FIG. 9 is an explanatory diagram illustrating a relationship between a capacity of the positive electrode and a capacity of the negative electrode in the battery device illustrated in FIG. 8.

FIG. 10 is a developed diagram schematically illustrating a positive electrode and a negative electrode of a battery device of a secondary battery according to an embodiment of the present disclosure.

FIG. 11 is an explanatory diagram illustrating a relationship between a capacity of the positive electrode and a capacity of the negative electrode in the battery device illustrated in FIG. 10.

### DETAILED DESCRIPTION

The present disclosure is described below in further detail including with reference to the drawings according to an embodiment.

A description is given first of a secondary battery according to a first embodiment of the present disclosure.

The secondary battery to be described here has a flat and columnar three-dimensional shape, and is commonly referred to as, for example, a coin type or a button type. As will be described later, the secondary battery includes two bottom parts opposed to each other, and a sidewall part positioned between the two bottom parts. The secondary battery has a height smaller than an outer diameter. As used herein, the term “outer diameter” refers to a maximum diameter (a maximum outer diameter) of each of the two bottom parts. In the secondary battery, the respective maximum diameters of the two bottom parts opposed to each other are substantially equal to each other. As used herein, the term “height” refers to a maximum distance from an upper surface of one of the bottom parts to a lower surface of another of the bottom parts. Note that, in the present embodiment, a direction in which the two bottom parts are opposed to each other is assumed to be a height direction Z.

Although a charge and discharge principle of the secondary battery is not particularly limited, the following description deals with a case where a battery capacity is obtained through insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode. Note that the secondary battery of the present embodiment is a high-charging-voltage secondary battery that is able to exhibit a favorable cyclability characteristic without lowering an energy density even when charging is performed at a high voltage of 4.38 V or higher.

The electrode reactant is not particularly limited in kind, and is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

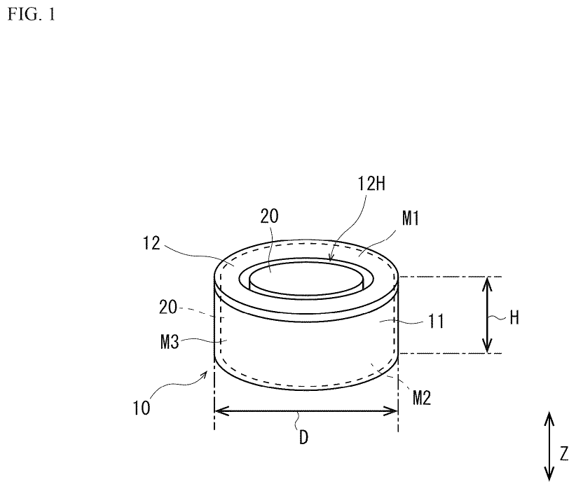

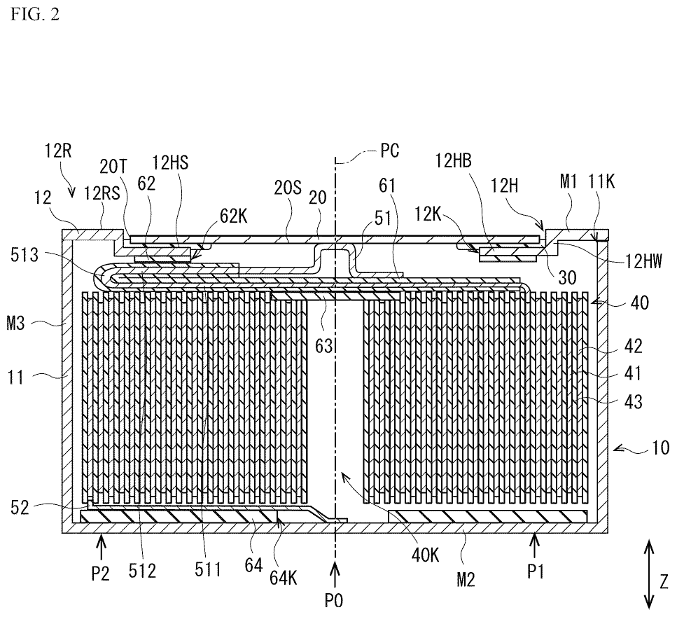

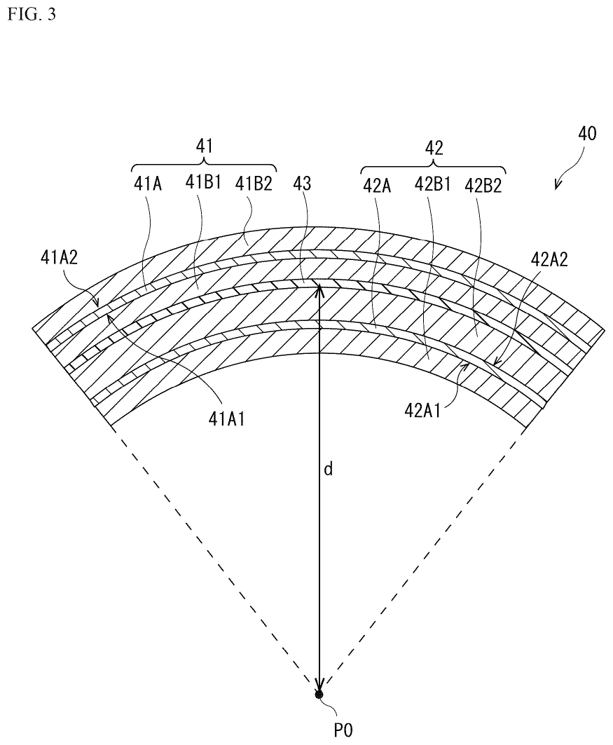

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2. Note that FIG. 3 illustrates only a portion of the sectional configuration of the battery device 40 in an enlarged manner.

For convenience, the following description is given with an upper side of each of FIGS. 1 and 2 assumed to be an upper side of the secondary battery, and a lower side of each of FIGS. 1 and 2 assumed to be a lower side of the secondary battery.

The secondary battery to be described here has a three-dimensional shape in which a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar). Note that, in the present embodiment, an up-down direction in a sheet plane in each of FIGS. 1 and 2 is assumed to be the height direction Z. Accordingly, the height H means a dimension, of the secondary battery of the present embodiment, in the height direction Z. The outer diameter D means a dimension, of the secondary battery of the present embodiment, in a direction orthogonal to the height direction Z.

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. That is, the outer diameter D is greater than the height H. Although not particularly limited, an upper limit of the ratio D/H is preferably less than or equal to 25.

As illustrated in FIGS. 1 to 3, the secondary battery includes an outer package can 10, an external terminal 20, the battery device 40, and a positive electrode lead 51. Here, the secondary battery further includes a gasket 30, a negative electrode lead 52, a sealant 61, and insulating films 62 and 63.

As illustrated in FIGS. 1 and 2, the outer package can 10 is a hollow outer package member that contains the battery device 40 and other components. The outer package can 10 includes an electrically conductive material.

Here, the outer package can 10 has a flat and substantially circular columnar three-dimensional shape corresponding to the three-dimensional shape of the secondary battery that is flat and circular columnar. Accordingly, the outer package can 10 includes two bottom parts M1 and M2 opposed to each other, and a sidewall part M3 positioned between the bottom parts M1 and M2. In other words, the sidewall part M3 couples the bottom part M1 and the bottom part M2 to each other, and surrounds the battery device 40. The sidewall part M3 has an upper end part coupled to the bottom part M1. The sidewall part M3 has a lower end part coupled to the bottom part M2. As described above, the outer package can 10 is substantially circular columnar. The bottom parts M1 and M2 are each circular in plan shape, and a surface of the sidewall part M3 is a convexly curved surface.

The outer package can 10 includes a container part 11 and a cover part 12 that are welded to each other. In other words, an internal space of the outer package can 10 is sealed by the cover part 12 being welded to the container part 11. Note that, in the present embodiment, the bottom part M1 configures the cover part 12, and the bottom part M2 and the sidewall part M3 integrally configure the container part 11. Accordingly, an outer edge of the cover part 12 is welded to the upper end part of the sidewall part M3.

The container part 11 is a container member that is to contain the battery device 40 and other components inside, and has a flat and circular columnar shape. The container part 11 has a hollow structure with an upper end part open and a lower end part closed. In other words, the container part 11 has an opening 11K (FIG. 2) at the upper end part. The opening 11K serves as a passing-through hole through which the battery device 40 is passable in the height direction Z.

The cover part 12 is a substantially disk-shaped cover member that closes the opening 11K of the container part 11, and has a through hole 12K. The through hole 12K is used as a coupling path for coupling the battery device 40 and the external terminal 20 to each other. The cover part 12 is welded to the container part 11 on the opening 11K, as described above. The external terminal 20 is attached to the cover part 12 with the gasket 30 interposed therebetween. That is, the cover part 12 supports the external terminal 20 with the gasket 30 interposed therebetween. The external terminal 20 is so attached to the cover part 12, with the gasket 30 interposed therebetween, as to close the through hole 12K. The external terminal 20 is electrically insulated from the outer package can 10.

In the secondary battery after completion, the cover part 12 is in a state of being welded to the container part 11 as described above. The opening 11K is closed with use of the cover part 12 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Thus, whether the container part 11 has had the opening 11K is recognizable afterward based on the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

The cover part 12 is so bent as to partly protrude along the height direction Z toward an inside of the container part 11 and thus forms a recessed part 12H. Specifically, as viewed from an outside of the outer package can 10, the cover part 12 is shaped to be partly recessed in the height direction Z toward the battery device 40 contained inside the outer package can 10. The recessed part 12H has the through hole 12K extending in the height direction Z, a bottom part 12HB surrounding the through hole 12K along a horizontal plane orthogonal to the height direction Z, and a wall part 12HW provided upright along an outer edge of the bottom part 12HB.

A portion of the cover part 12 other than the recessed part 12H is a peripheral part 12R. The peripheral part 12R is provided to surround the recessed part 12H and has an annular shape in the horizontal plane orthogonal to the height direction Z of the secondary battery. The peripheral part 12R is a portion that surrounds a periphery of the recessed part 12H and protrudes away from the battery device 40 along the height direction Z. Accordingly, a surface 12HS of the bottom part 12HB of the recessed part 12H is at a low position in the height direction Z toward the inside of the container part 11 as compared with a surface 12RS of the peripheral part 12R. In other words, a distance between the surface 12HS of the bottom part 12HB of the recessed part 12H and the battery device 40 in the height direction Z is shorter than a distance between the surface 12RS of the peripheral part 12R and the battery device 40 in the height direction Z.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired. However, the depth of the recessed part 12H is set to allow a height position of a surface 20S of the external terminal 20 to be lower than a height position of the surface 12RS of the peripheral part 12R, in a state where the external terminal 20 is attached to the recessed part 12H with the gasket 30 interposed therebetween.

As described above, the outer package can 10 is what is called a welded can in which the container part 11 and the cover part 12 that have been physically separate from each other are welded to each other. Thus, the outer package can 10 after the welding is a single member that is physically integral as a whole, and is in a state of being not separable into the container part 11 and the cover part 12 afterward.

The outer package can 10 that is the welded can is different from a crimped can formed by crimping processing, and is what is called a crimpless can. One reason for this is to increase a device space volume inside the outer package can 10 and to thereby increase an energy density per unit volume. The term “device space volume” refers to a volume (an effective volume) of the internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive. To be more specific, the container part 11 and the cover part 12 are each electrically conductive. The outer package can 10 is electrically coupled to a negative electrode 42 of the battery device 40 via the negative electrode lead 52. Accordingly, the outer package can 10 also serves as an external coupling terminal of the negative electrode 42. It is unnecessary for the secondary battery of the present embodiment to be provided with the external coupling terminal of the negative electrode 42 separate from the outer package can 10, which suppresses a decrease in device space volume resulting from providing the external coupling terminal of the negative electrode 42. As a result, the device space volume increases, and the energy density per unit volume increases accordingly.

Specifically, the outer package can 10 is a metal can that includes any one or more of electrically conductive materials including, without limitation, a metal material and an alloy material. Examples of the electrically conductive material included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

The cover part 12 is insulated, via the gasket 30, from the external terminal 20 serving as an external coupling terminal of a positive electrode 41. One reason for this is to prevent contact, or a short circuit, between the outer package can 10 that is the external coupling terminal of the negative electrode 42 and the external terminal 20 that is the external coupling terminal of the positive electrode 41.

As illustrated in FIGS. 1 and 2, the external terminal 20 is a coupling terminal to be coupled to electronic equipment when the secondary battery is mounted on the electronic equipment. As described above, the external terminal 20 is attached to the cover part 12 of the outer package can 10 to be supported by the cover part 12. The external terminal 20 is provided at a position that is on an opposite side of the cover part 12 to the bottom part M2, and that overlaps the through hole 12K in the height direction Z.

Here, the external terminal 20 is coupled to the positive electrode 41 of the battery device 40 via the positive electrode lead 51. Accordingly, the external terminal 20 also functions as the external coupling terminal of the positive electrode 41. Accordingly, upon use of the secondary battery, the secondary battery is coupled to electronic equipment via the external terminal 20 (the external coupling terminal of the positive electrode 41) and the outer package can 10 (the external coupling terminal of the negative electrode 42). This allows the electronic equipment to operate with use of the secondary battery as a power source.

The external terminal 20 is a flat and substantially plate-shaped member that extends along the horizontal plane orthogonal to the height direction Z of the secondary battery, and is disposed inside the recessed part 12H with the gasket 30 interposed between the external terminal 20 and the recessed part 12H. The external terminal 20 is insulated from the cover part 12 via the gasket 30. Here, as illustrated in FIG. 2, a position of the surface 20S of the external terminal 20 is low in the height direction Z toward the battery device 40 as compared with a position of the surface 12RS of the peripheral part 12R of the outer package can 10. In other words, the external terminal 20 is contained inside the recessed part 12H in such a manner that the surface 20S, which is an upper end of the external terminal 20, is recessed toward the battery device 40 as compared with the surface 12RS. In the secondary battery of the present embodiment, the height of the secondary battery is reduced as compared with a case where the external terminal 20 protrudes above the cover part 12. This increases the energy density per unit volume of the secondary battery. This also makes it possible to prevent a short circuit between the outer package can 10 and the external terminal 20 from being caused by another electrically conductive member. Further, in the present embodiment, a peripheral region of the external terminal 20 overlaps the bottom part 12HB of the recessed part 12H in the height direction Z. Owing to the external terminal 20 and the cover part 12 having an overlap region, it is possible to improve mechanical strength of the secondary battery as a whole. Here, a length, of the overlap region of the external terminal 20 and the peripheral region, along the horizontal plane orthogonal to the height direction Z is preferably greater than a thickness of the external terminal 20 and greater than a thickness of the bottom part 12HB.

Note that the external terminal 20 has an outer diameter smaller than the inner diameter of the recessed part 12H. Thus, an outer edge 20T of the external terminal 20 is spaced from the cover part 12. The gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. However, the gasket 30 is preferably also provided between an inner wall face of the wall part 12HW of the recessed part 12H and the outer edge 20T of the external terminal 20. Further, the cover part 12 and the external terminal 20 are preferably stuck to each other by the gasket 30.

Further, the external terminal 20 includes any one or more of electrically conductive materials including, without limitation, a metal material and an alloy material. Examples of the electrically conductive materials include aluminum and an aluminum alloy. However, the external terminal 20 may include a cladding material. The cladding material includes an aluminum layer and a nickel layer disposed in this order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 with the gasket 30 interposed therebetween. The gasket 30 is ring-shaped in a plan view and has a through hole at a location corresponding to the through hole 12K. The gasket 30 includes any one or more of insulating materials including, without limitation, a polymer compound having an insulating property. The insulating materials are resins including, without limitation, polypropylene and polyethylene.

A range of placement of the gasket 30 is not particularly limited, and may be chosen as desired. Here, the gasket 30 is disposed in a gap between an upper surface of the cover part 12 and a lower surface of the external terminal 20, inside the recessed part 12H. However, as described above, the gasket 30 is preferably also provided between the inner wall face of the wall part 12HW of the recessed part 12H and the outer edge 20T of the external terminal 20. Further, the cover part 12 and the external terminal 20 are preferably stuck to each other by the gasket 30.

The battery device 40 is a power generation device that causes charging and discharging reactions to proceed. As illustrated in FIGS. 2 and 3, the battery device 40 is contained inside the outer package can 10. The battery device 40 includes the positive electrode 41 and the negative electrode 42. Here, the battery device 40 further includes a separator 43 and an electrolytic solution. The electrolytic solution is a liquid electrolyte, and is not illustrated.

A center line PC illustrated in FIG. 2 is a line segment corresponding to a center of the battery device 40 in a direction along the outer diameter D of the secondary battery (the outer package can 10). More specifically, a position P0 of the center line PC corresponds to a position of the center of the battery device 40.

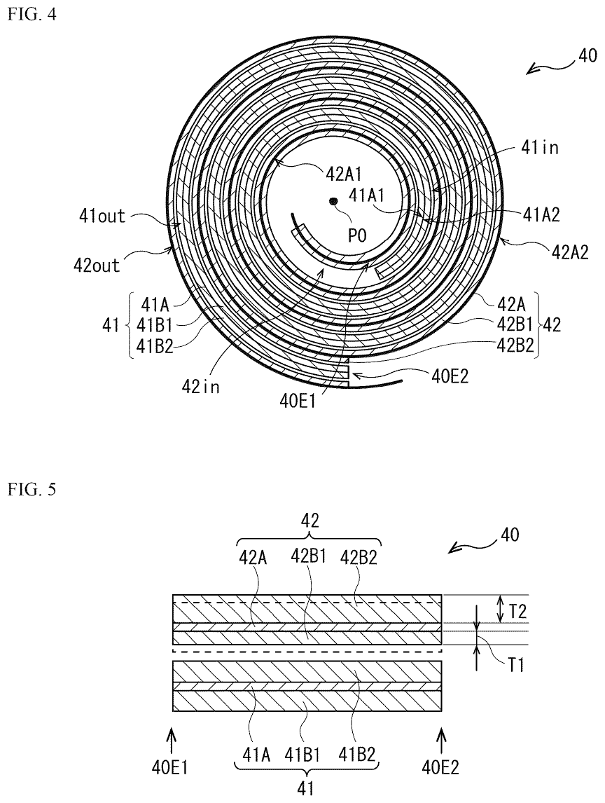

The battery device 40 is what is called a wound electrode body. More specifically, in the battery device 40, the positive electrode 41 and the negative electrode 42 are stacked on each other with the separator 43 interposed therebetween. In addition, as illustrated in FIG. 4, the stack of the positive electrode 41, the negative electrode 42, and the separator 43 is wound around the center line PC as a winding axis. The positive electrode 41 and the negative electrode 42 are wound, remaining in a state of being opposed to each other with the separator 43 interposed therebetween. As a result, a winding center space 40K is present at the center of the battery device 40. Note that FIG. 4 illustrates a configuration example of the battery device 40 along a horizontal section orthogonal to the height direction Z. Note that, for ensuring visibility, FIG. 4 omits illustration of the separator 43.

Here, the positive electrode 41, the negative electrode 42, and the separator 43 are so wound that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired. Further, in the outermost wind of the battery device 40, the negative electrode 42 is positioned on an outer side relative to the positive electrode 41. In other words, as illustrated in FIG. 4, an outermost positive electrode wind part 41out that is positioned in an outermost wind of the positive electrode 41 included in the battery device 40 is positioned on an inner side relative to an outermost negative electrode wind part 42out that is positioned in an outermost wind of the negative electrode 42 included in the battery device 40. Here, the outermost positive electrode wind part 41out is a part corresponding to the outermost one wind of the positive electrode 41 in the battery device 40. Here, the outermost negative electrode wind part 42out is a part corresponding to the outermost one wind of the negative electrode 42 in the battery device 40. In contrast, in an innermost wind of the battery device 40, the negative electrode 42 is positioned on the inner side relative to the positive electrode 41. In other words, as illustrated in FIG. 4, an innermost negative electrode wind part 42 in that is positioned in an innermost wind of the negative electrode 42 included in the battery device 40 is positioned on an inner side relative to an innermost positive electrode wind part 41 in that is positioned in an innermost wind of the positive electrode 41 included in the battery device 40. Here, the innermost positive electrode wind part 41 in is a part corresponding to the innermost one wind of the positive electrode 41 in the battery device 40. Here, the innermost negative electrode wind part 42 in is a part corresponding to the innermost one wind of the negative electrode 42 in the battery device 40.

The battery device 40 has a three-dimensional shape similar to the three-dimensional shape of the outer package can 10. Specifically, the battery device 40 has a flat and substantially circular columnar three-dimensional shape. This helps to prevent what is called a dead space, more specifically, a gap between the outer package can 10 and the battery device 40, from easily being provided when the battery device 40 is placed inside the outer package can 10, as compared with a case where the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

The positive electrode 41 is a first electrode to be used to cause the charging and discharging reactions to proceed. As illustrated in FIGS. 3 and 4, the positive electrode 41 includes a positive electrode current collector 41A and a positive electrode active material layer 41B.

The positive electrode current collector 41A has two opposed surfaces on each of which the positive electrode active material layer 41B is to be provided. More specifically, the positive electrode current collector 41A includes an inward positive electrode current collector surface 41A1 facing toward a winding center side of the battery device 40, that is, facing toward the position P0, and an outward positive electrode current collector surface 41A2 facing toward an opposite side to the winding center side of the battery device 40, that is, positioned on an opposite side to the inward positive electrode current collector surface 41A1. The positive electrode current collector 41A includes an electrically conductive material such as a metal material. Examples of the metal material include aluminum.

The positive electrode 41 includes, as the positive electrode active material layers 41B, an inner side positive electrode active material layer 41B1 covering all or a part of the inward positive electrode current collector surface 41A1, and an outer side positive electrode active material layer 41B2 covering all or a part of the outward positive electrode current collector surface 41A2. The inner side positive electrode active material layer 41B1 and the outer side positive electrode active material layer 41B2 may include the same material, and may have the same thickness. Note that in the present specification, the inner side positive electrode active material layer 41B1 and the outer side positive electrode active material layer 41B2 may each be generically referred to as the positive electrode active material layer 41B, without being distinguished from each other. The positive electrode active material layer 41B includes any one or more of positive electrode active materials into which lithium is insertable and from which lithium is extractable. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. One reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 42 is a second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. More specifically, the negative electrode current collector 42A includes an inward negative electrode current collector surface 42A1 facing toward the winding center side of the battery device 40, that is, facing toward the position P0, and an outward negative electrode current collector surface 42A2 facing toward the opposite side to the winding center side of the battery device 40, that is, positioned on an opposite side to the inward negative electrode current collector surface 42A1. The negative electrode current collector 42A includes an electrically conductive material such as a metal material. Examples of the metal material include copper.

The negative electrode 42 includes, as the negative electrode active material layers 42B, an inner side negative electrode active material layer 42B1 covering all or a part of the inward negative electrode current collector surface 42A1, and an outer side negative electrode active material layer 42B2 covering all or a part of the outward negative electrode current collector surface 42A2. An area density of the outer side negative electrode active material layer 42B2 is higher than an area density of the inner side negative electrode active material layer 42B1 over a region from an inner winding side end part 40E1 of the battery device 40 to an outer winding side end part 40E2 of the battery device 40. For example, where the area density of the outer side negative electrode active material layer 42B2 is 101.8%, the area density of the inner side negative electrode active material layer 42B1 is 98.2%. In the negative electrode 42, for example, the inner side negative electrode active material layer 42B1 and the outer side negative electrode active material layer 42B2 include the same material, and, as illustrated in FIG. 5, a thickness T2 of the outer side negative electrode active material layer 42B2 is greater than a thickness T1 of the inner side negative electrode active material layer 42B1 over the region from the inner winding side end part 40E1 of the battery device 40 to the outer winding side end part 40E2 of the battery device 40. FIG. 5 is a developed diagram schematically illustrating the positive electrode 41 and the negative electrode 42 of the battery device 40. Note that a dashed line in FIG. 5 illustrates the inner side negative electrode active material layer 42B1 and the outer side negative electrode active material layer 42B2 when the thickness T1 and the thickness T2 are equal to each other. In the present specification, the inner side negative electrode active material layer 42B1 and the outer side negative electrode active material layer 42B2 may each be generically referred to as the negative electrode active material layer 42B, without being distinguished from each other. As used herein, the term “inner winding side end part 40E1” means an innermost end part of a part in which the positive electrode active material layer 41B and the negative electrode active material layer 42B are opposed to each other in the battery device 40. As used herein, the term “outer winding side end part 40E2” means an outermost end part of the part in which the positive electrode active material layer 41B and the negative electrode active material layer 42B are opposed to each other in the battery device 40.

The negative electrode active material layer 42B includes any one or more of negative electrode active materials into which lithium is insertable and from which lithium is extractable. Note that the negative electrode active material layer 42B may further include other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. One reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. One reason for this is to prevent precipitation of lithium extracted from the positive electrode 41. The term “height” refers to a dimension corresponding to the height H of the secondary battery described above, that is, a dimension in the up-down direction in each of FIGS. 1 and 2. The definition of the height described here applies also to the following.

The separator 43 is an insulating porous film interposed between the positive electrode 41 and the negative electrode 42, as illustrated in FIGS. 2 and 3. The separator 43 allows lithium ions to pass through the separator 43 and prevents a short circuit between the positive electrode 41 and the negative electrode 42. The separator 43 includes a polymer compound such as polyethylene.

Here, the separator 43 has a height greater than the height of the negative electrode 42, as illustrated in FIG. 2. More specifically, the separator 43 preferably protrudes above the negative electrode 42 and protrudes below the negative electrode 42.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is contained inside the outer package can 10. The positive electrode lead 51 is coupling wiring coupled to each of the positive electrode 41 and the external terminal 20. The secondary battery illustrated in FIG. 2 includes one positive electrode lead 51. However, the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to a portion of the surface 20S of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 2, the positive electrode lead 51 includes a first part 511, a second part 512, and a turning part 513. The first part 511 and the second part 512 each extend along the horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other. The first part 511 and the second part 512 are sandwiched between the battery device 40 and the recessed part 12H of the cover part 12 in the height direction Z of the secondary battery.

In this way, the portion of the positive electrode lead 51 is held by the cover part 12 and the battery device 40 by extending along each of a lower surface of the cover part 12 and an upper surface of the battery device 40. This allows the positive electrode lead 51 to be fixed inside the outer package can 10. By preventing the positive electrode lead 51 from easily moving even if the secondary battery experiences an external force such as vibration or impact, the positive electrode lead 51 is prevented from being easily damaged. Examples of damage to the positive electrode lead 51 referred to above include cracking of the positive electrode lead 51, breakage of the positive electrode lead 51, and detachment of the positive electrode lead 51 from the positive electrode 41.

More specifically, the wording “a portion of the positive electrode lead 51 is sandwiched by the outer package can 10 and the battery device 40” means that the positive electrode lead 51 is held by the outer package can 10 and the battery device 40 from above and below while being insulated from each of the outer package can 10 and the battery device 40, and that the positive electrode lead 51 is thus in a state of being not easily movable inside the outer package can 10 even if the secondary battery experiences an external force such as vibration or impact. The state where the positive electrode lead 51 is not easily movable inside the outer package can 10 exactly indicates that the battery device 40 is also in the state of being not easily movable inside the outer package can 10. This helps to also avoid a defect of the battery device 40, i.e., the wound electrode body, such as winding deformation when the secondary battery experiences vibration or impact.

Note that the positive electrode lead 51 is preferably partially embedded in the battery device 40 because of being pressed by the battery device 40. More specifically, the positive electrode lead 51 is preferably partially embedded in an upper end part of the separator 43 because of the height of the separator 43 being greater than the height of each of the positive electrode 41 and the negative electrode 42 as described above. In such a case, a recessed part is formed in the upper end part of the separator 43 because of being pressed by the positive electrode lead 51. All or a part of the positive electrode lead 51 is received in the recessed part, which allows the positive electrode lead 51 to be held by the separator 43. One reason for this is to further prevent the positive electrode lead 51 from easily moving inside the outer package can 10, and to thereby further prevent the positive electrode lead 51 from being easily damaged.

Here, as described above, the cover part 12 includes the recessed part 12H, and a portion of the positive electrode lead 51 is sandwiched by the recessed part 12H and the battery device 40. More specifically, a portion of the positive electrode lead 51 is held by the recessed part 12H and the battery device 40 by extending along each of a lower surface of the recessed part 12H and the upper surface of the battery device 40. The recessed part 12H helps to hold the positive electrode lead 51 more easily. This further prevents the positive electrode lead 51 from being easily damaged.

Further, a portion of the positive electrode lead 51 is insulated from the cover part 12 and the negative electrode 42 via each of the separator 43, the sealant 61, and the insulating films 62 and 63.

Specifically, as described above, the height of the separator 43 is greater than the height of the negative electrode 42. Accordingly, a portion of the positive electrode lead 51 is separate from the negative electrode 42 via the separator 43, and is thus insulated from the negative electrode 42 via the separator 43. One reason for this is to prevent a short circuit between the positive electrode lead 51 and the negative electrode 42.

Further, the positive electrode lead 51 is covered at a periphery thereof by the sealant 61 having an insulating property. A portion of the positive electrode lead 51 is thus insulated from each of the cover part 12 and the negative electrode 42 via the sealant 61. One reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. A portion of the positive electrode lead 51 is thus insulated from the cover part 12 via the insulating film 62. One reason for this is to prevent a short circuit between the positive electrode lead 51 and the cover part 12.

In addition, the insulating film 63 is disposed between the battery device 40 and the positive electrode lead 51. A portion of the positive electrode lead 51 is thus insulated from the negative electrode 42 via the insulating film 63. One reason for this is to prevent a short circuit between the positive electrode lead 51 and the negative electrode 42.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

Here, the positive electrode lead 51 is coupled to the positive electrode 41 in a region on a front side relative to the center line PC, i.e., a region on a right side relative to the center line PC in FIG. 2. In order to be coupled to the external terminal 20, the positive electrode lead 51 includes the turning part 513 in the middle of extension to the external terminal 20. The turning part 513 is present in a region on a back side relative to the center line PC, i.e., a region on a left side relative to the center line PC in FIG. 2. The positive electrode lead 51 includes the first part 511 that corresponds to a part that lies from a location where the positive electrode lead 51 is coupled to the positive electrode 41, through the position P0 that is the center, to the turning part 513. The first part 511 extends along the upper surface of the battery device 40 in a direction orthogonal to the height direction Z. In addition, the positive electrode lead 51 includes the second part 512 that corresponds to a part in the middle of extension from the turning part 513 to a location where the positive electrode lead 51 is coupled to the external terminal 20. The second part 512 extends along the upper surface of the battery device 40 in the direction orthogonal to the height direction Z in such a manner as to be laid over the first part 511. As described above, a portion of the positive electrode lead 51 is sandwiched by the cover part 12 and the battery device 40 and extends toward the external terminal 20, in both the region on the front side relative to the center line PC and the region on the back side relative to the center line PC.

Here, as is apparent from FIG. 2, “the region on the front side relative to the center line PC” is, where the battery device 40 is divided into two regions with respect to the center line PC in a direction along the outer diameter D, one region in which the location where the positive electrode lead 51 is coupled to the positive electrode 41 is present. In FIG. 2, “the region on the front side relative to the center line PC” is the region on the right side relative to the center line PC. In contrast, as is apparent from FIG. 2, “the region on the back side relative to the center line PC” is another region of the two regions, and is the region on the left side relative to the center line PC in FIG. 2. In other words, “the region on the back side relative to the center line PC” is, where the battery device 40 is divided into the two regions with respect to the center line PC in the direction along the outer diameter D, the other region in which the location where the positive electrode lead 51 is coupled to the positive electrode 41 is absent.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to the outermost wind of the positive electrode 41. One reason for this is that corrosion of the outer package can 10 caused by creeping up of the electrolytic solution is suppressed unlike when the positive electrode lead 51 is coupled to the positive electrode 41 in the outermost wind of the positive electrode 41. The wording “creeping up of the electrolytic solution” refers to a phenomenon in which, when the positive electrode lead 51 is disposed in proximity to an inner wall face of the outer package can 10, the electrolytic solution in the battery device 40 creeps up along the positive electrode lead 51 to reach the inner wall face of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the extending direction of the positive electrode lead 51 changes at an angle greater than 90° in the middle of the positive electrode lead 51. The positive electrode lead 51 preferably has, at a location where the positive electrode lead 51 is turned up, a curved shape rather than a bent shape, as with the turning part 513. Further, although FIG. 2 illustrates an example in which the positive electrode lead 51 includes one turning part 513, the positive electrode lead 51 may include multiple turning parts 513.

The positive electrode lead 51 is turned up at the turning part 513 in the middle of extension from the positive electrode 41 to the external terminal 20. Specifically, as illustrated in FIG. 2, the first part 511 extends from a first position P1 to a second position P2 in the horizontal plane orthogonal to the height direction of the secondary battery. The first position P1 is other than the position P0 that is the center of the outer package can 10. The second position P2 is on an opposite side of the center position to the first position P1. The second part 512 extends from the second position P2 toward the position P0 that is the center. In the positive electrode lead 51, an overlap region of the first part 511 and the second part 512 is a surplus portion. It can thus be said that the positive electrode lead 51 has a length margin in a longitudinal direction of the positive electrode lead 51.

This provides room to change orientation of the cover part 12 relative to the container part 11 when forming the outer package can 10 by using the container part 11 and the cover part 12 in a process of manufacturing the secondary battery, as will be described later. Further, when the secondary battery experiences an external force such as vibration or impact, the length margin of the positive electrode lead 51 is usable to mitigate the external force, thereby helping to prevent the positive electrode lead 51 from being easily damaged. Furthermore, the length margin of the positive electrode lead 51 is usable to change the position of coupling of the positive electrode lead 51 to the positive electrode 41 to a desired position without changing the positive electrode lead 51 in length.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. One reason for this is to ensure that the length of the positive electrode lead 51 has a length margin allowing for raising the cover part 12 relative to the container part 11, and to thereby make it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from easily becoming detached from the external terminal 20 and be narrow enough to allow for the length margin of the positive electrode lead 51, in particular. One reason why the range of coupling of the positive electrode lead 51 to the external terminal 20 is preferably narrow enough is that a sufficiently large length margin of the positive electrode lead 51 is achievable because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10. The negative electrode lead 52 is electrically coupled to each of the negative electrode 42 and the outer package can 10 (the container part 11). Accordingly, the container part 11 (the bottom part M2) is electrically coupled to the negative electrode 42 via the negative electrode lead 52. Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. A method of coupling the negative electrode lead 52 is not particularly limited, and specifically includes any one or more of welding methods including, without limitation, the resistance welding method and the laser welding method.

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

A position of coupling of the negative electrode lead 52 to the negative electrode 42 is not particularly limited, and may be chosen as desired. Here, the negative electrode lead 52 is coupled to an outermost wind part of the negative electrode 42 included in the wound electrode body.

Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

The sealant 61 is a first insulating member covering the periphery of the positive electrode lead 51, as illustrated in FIG. 2. The sealant 61 includes two insulating tapes each being attached to corresponding one of a front surface and a back surface of the positive electrode lead 51. Here, to allow the positive electrode lead 51 to be coupled to each of the positive electrode 41 and the external terminal 20, the sealant 61 covers the periphery of a portion in the middle of the positive electrode lead 51. Note that a structure of the sealant 61 is not limited to a tape-shaped structure, and the sealant 61 may have a tube-shaped structure, for example.

The sealant 61 includes any one or more of insulating materials including, without limitation, a polymer compound having an insulating property. Examples of the insulating materials include polyimide.

The insulating film 62 is an insulating member disposed between the cover part 12 and the battery device 40 in the height direction Z, as illustrated in FIG. 2. Here, the insulating film 62 is ring-shaped in a plan view and has an opening 62K at a location corresponding to the through hole 12K in the height direction Z.

Here, the insulating film 62 may be adhered to the cover part 12 via an adhesive layer.

The insulating film 62 may include any one or more of insulating materials including, without limitation, a polymer compound having an insulating property. Examples of the one or more insulating materials to be included in the insulating film 62 include polyimide.

The insulating film 63 is an insulating member disposed between the battery device 40 and the positive electrode lead 51, as illustrated in FIG. 2. Here, the insulating film 63 is flat plate-shaped in a plan view. The insulating film 63 is disposed to close the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same as or different from each other.

Note that the secondary battery may further include one or more other components according to an embodiment.

Specifically, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include the occurrence of a short circuit inside the secondary battery and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator other than the insulating films 62 and 64 between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, and more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 through the electrolytic solution. Upon discharging of the secondary battery, in the battery device 40, lithium is extracted from the negative electrode 42, and the extracted lithium is inserted into the positive electrode 41 through the electrolytic solution. Upon charging and discharging, lithium is inserted and extracted in an ionic state.

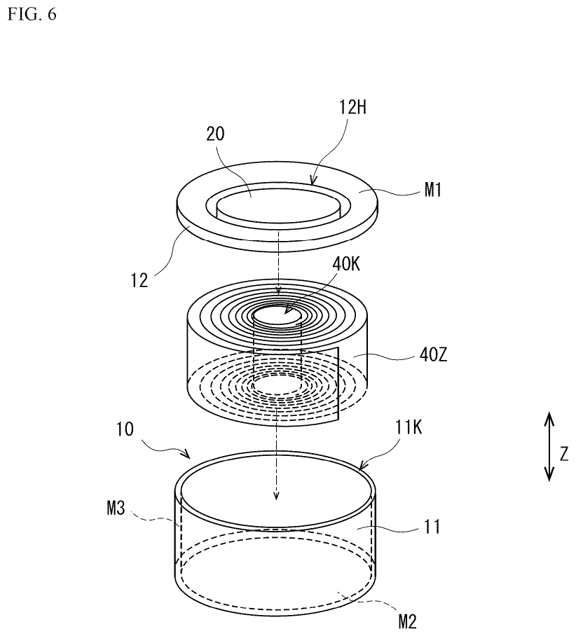

FIG. 6 illustrates a perspective configuration of the outer package can 10 to be used in the process of manufacturing the secondary battery, and corresponds to FIG. 1.

FIG. 6 illustrates a state where the cover part 12 is separate from the container part 11 before the cover part 12 is welded to the container part 11.

In the following description, where appropriate, FIGS. 1 to 5 described already will be referred to in conjunction with FIG. 6.

Here, as illustrated in FIG. 6, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby produce a positive electrode mixture. Thereafter, the positive electrode mixture thus produced is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated by a procedure similar to the fabrication procedure of the positive electrode 41. Specifically, a negative electrode mixture, which is obtained by mixing the negative electrode active material and other materials including, without limitation, the negative electrode binder and the negative electrode conductor with each other, is put into an organic solvent to thereby prepare a negative electrode mixture slurry in paste form, following which the negative electrode mixture slurry is applied on the two opposed surfaces of the negative electrode current collector 42A to thereby form the negative electrode active material layers 42B. At this time, the negative electrode active material layers 42B are so formed as to allow the thickness T2 of the outer side negative electrode active material layer 42B2 covering the outward negative electrode current collector surface 42A2 to be greater than the thickness T1 of the inner side negative electrode active material layer 42B1 covering the inward negative electrode current collector surface 42A1. Thereafter, the negative electrode active material layers 42B are compression-molded by, for example, a roll pressing machine. In this manner, the negative electrode 42 is fabricated.

The electrolyte salt is put into the solvent. The electrolyte salt is thereby dispersed or dissolved in the solvent. As a result, the electrolytic solution is prepared.

First, by the welding method such as the resistance welding method, the positive electrode lead 51 covered at the periphery thereof by the sealant 61 is coupled to the positive electrode 41 (the positive electrode current collector 41A), and the negative electrode lead 52 is coupled to the negative electrode 42 (the negative electrode current collector 42A).

Thereafter, the positive electrode 41 and the negative electrode 42 are stacked on each other with the separator 43 interposed therebetween, following which the stack including the positive electrode 41, the negative electrode 42, and the separator 43 is wound to thereby fabricate a wound body 40Z, as illustrated in FIG. 6. The wound body 40Z has a configuration similar to the configuration of the battery device 40 except that the positive electrode 41, the negative electrode 42, and the separator 43 are each unimpregnated with the electrolytic solution. Note that FIG. 6 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In this case, the negative electrode lead 52 is coupled to the container part 11 by the welding method such as the resistance welding method. Thereafter, the insulating film 63 is placed on the wound body 40Z.

Thereafter, the cover part 12 to which the external terminal 20 is attached in advance with the gasket 30 being interposed between the cover part 12 and the external terminal 20 and on which the insulating film 62 is provided in advance is prepared, following which the positive electrode lead 51 is coupled to the external terminal 20 through the through hole 12K by the welding method such as the resistance welding method.

As a result, the wound body 40Z (the positive electrode 41) contained inside the container part 11 and the external terminal 20 attached to the cover part 12 are coupled to each other via the positive electrode lead 51.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. Thus, the battery device 40, i.e., the wound electrode body, is fabricated.

Thereafter, the cover part 12 is brought down into close proximity to the container part 11 to thereby close the opening 11K with the cover part 12, following which the cover part 12 is welded to the container part 11 by the welding method such as the laser welding method. In this case, as illustrated in FIG. 2, a portion of the positive electrode lead 51 is sandwiched between the cover part 12 and the battery device 40, and the turning part 513 that is curved is formed on the back side relative to the location where the positive electrode lead 51 is coupled to the external terminal 20. In this manner, the outer package can 10 is formed, and the battery device 40 and other components are contained inside the outer package can 10. Assembly of the secondary battery is thus completed.

The assembled secondary battery is charged and discharged. Various conditions including, for example, an environment temperature, the number of times of charging and discharging (the number of cycles), and charging and discharging conditions may be set as desired. As a result, a film is formed on a surface of, for example, the negative electrode 42. This brings the secondary battery into an electrochemically stable state. As a result, the secondary battery is completed.

As described above, in the secondary battery of the present embodiment, in the battery device 40, the area density of the outer side negative electrode active material layer 42B2 is higher than the area density of the inner side negative electrode active material layer 42B1 over the region from the inner winding side end part 40E1 to the outer winding side end part 40E2. This allows, in terms of a relationship between the positive electrode 41 and the negative electrode 42 that are opposed to each other with the separator 43 interposed therebetween, a capacity of the negative electrode 42 to be greater than a capacity of the positive electrode 41. Specifically, in terms of a relationship between the inner side positive electrode active material layer 41B1 and the outer side negative electrode active material layer 42B2 that are opposed to each other with the separator 43 interposed therebetween, it is possible to allow a capacity of the outer side negative electrode active material layer 42B2 to be greater than a capacity of the inner side positive electrode active material layer 41B1. As a result, it is possible for the secondary battery of the present embodiment to suppress generation of a deposited matter such as lithium metal caused by a battery reaction upon charging, and to suppress a decrease in battery performance. Accordingly, the secondary battery achieves high reliability.

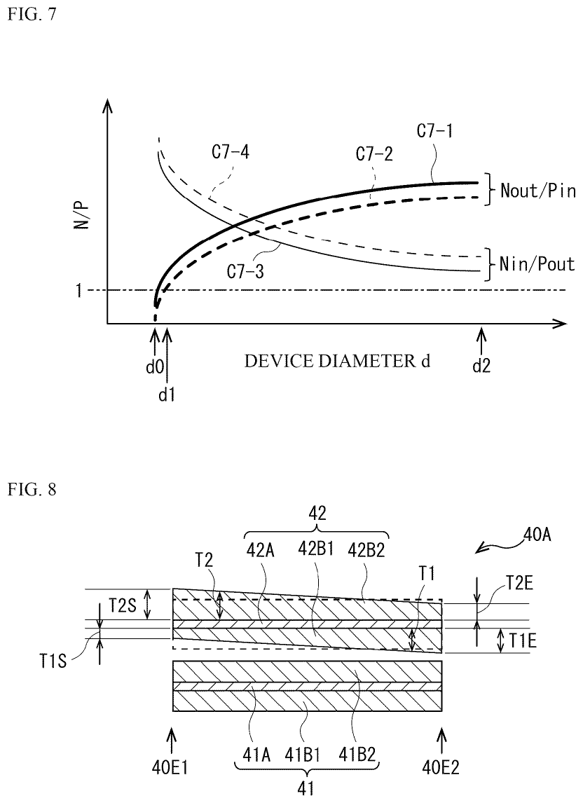

Action and effects of the secondary battery according to the present embodiment are described below in detail with reference to FIG. 7. FIG. 7 is an explanatory diagram illustrating a relationship between the capacity of the positive electrode 41 and the capacity of the negative electrode 42 in the battery device 40. A horizontal axis in FIG. 7 represents a device diameter d, and a vertical axis in FIG. 7 represents N/P as a ratio of a negative electrode capacity N to a positive electrode capacity P. Specifically, the device diameter d is a distance from the position P0, i.e., the center of the battery device 40, to any position of the separator 43, as illustrated in FIG. 3. N/P represents a capacity ratio between the positive electrode active material layer 41B and the negative electrode active material layer 42B that are opposed to each other with the separator 43 located at a position of the device diameter d interposed therebetween. As illustrated in FIG. 7, N/P continuously changes depending on a dimension of the device diameter d. More specifically, out of four curves presented in FIG. 7, two curves C7-1 and C7-2 in each of which N/P increases with an increase in the device diameter d each represent Nout/Pin that is a ratio of the capacity of the outer side negative electrode active material layer 42B2 to the capacity of the inner side positive electrode active material layer 41B1. Out of the two curves C7-1 and C7-2, the curve C7-1 indicated by a solid line represents Nout/Pin of the secondary battery according to the present embodiment, and the curve C7-2 indicated by a dashed line represents Nout/Pin of a secondary battery according to a comparative example in which the area density of the outer side negative electrode active material layer 42B2 and the area density of the inner side negative electrode active material layer 42B1 are substantially equal to each other. Out of the four curves presented in FIG. 7, two curves C7-3 and C7-4 in each of which N/P decreases with an increase in the device diameter d each represent Nin/Pout that is a ratio of a capacity of the inner side negative electrode active material layer 42B1 to a capacity of the outer side positive electrode active material layer 41B2. Out of the two curves C7-3 and C7-4, the curve C7-3 indicated by a solid line represents Nin/Pout of the secondary battery according to the present embodiment, and the curve C7-4 indicated by a dashed line represents Nin/Pout of the secondary battery according to the comparative example in which the area density of the outer side negative electrode active material layer 42B2 and the area density of the inner side negative electrode active material layer 42B1 are substantially equal to each other.

As is apparent from FIG. 7, a region in which the device diameter d is smaller has a wider gap between Nout/Pin and Nin/Pout. Nout/Pin is particularly small in a region in which the device diameter d is small. The secondary battery of the comparative example thus has Nout/Pin of less than 1 in a region in which the device diameter d is smaller than d1 (see the curve C7-2). In such a case, the generation of the deposited matter such as lithium metal caused by the battery reaction easily occurs particularly when charging is performed at a high voltage. In contrast, in the secondary battery of the present embodiment indicated by the solid line, it is possible to suppress a decrease in Nout/Pin in the region in which the device diameter d is small, and to allow Nout/Pin to be 1 or more in a region in which the device diameter d is greater than or equal to do (see the curve C7-1). Accordingly, it is possible for the secondary battery of the present embodiment to suppress the generation of the deposited matter such as lithium metal caused by the battery reaction upon charging, and to suppress a decrease in battery performance. Further, according to the secondary battery of the present embodiment, it is possible to reduce a difference between Nout/Pin and Nin/Pout over the region from the inner winding side end part 40E1 to the outer winding side end part 40E2, which is advantageous for improving a cyclability characteristic.

Further, in the secondary battery of the present embodiment, the cover part 12 is provided with the recessed part 12H, and the external terminal 20 is disposed in the recessed part 12H. This makes it possible to reduce a height dimension of the secondary battery while ensuring a battery capacity.

Further, the secondary battery may have the flat and columnar shape, that is, the secondary battery may be a secondary battery that is referred to as, for example, the coin type or the button type. In such a case, the positive electrode lead 51 is prevented from being easily damaged even in a small-sized secondary battery that is highly constrained in terms of size. Accordingly, it is possible to achieve higher effects in terms of physical durability.

Further, the secondary battery may be a lithium-ion secondary battery. In such a case, it is possible to stably obtain a sufficient battery capacity through the use of insertion and extraction of lithium.

Next, with reference to FIG. 8, a description is given of a secondary battery according to a second embodiment of the present disclosure. FIG. 8 is a developed diagram schematically illustrating the positive electrode 41 and the negative electrode 42 of a battery device 40A of the secondary battery according to the second embodiment of the present disclosure. FIG. 8 corresponds to FIG. 5 illustrating the developed diagram of the battery device 40 of the secondary battery according to the first embodiment described above.

In the battery device 40 of the secondary battery according to the first embodiment described above, the area density of the outer side negative electrode active material layer 42B2 is higher than the area density of the inner side negative electrode active material layer 42B1 over the region from the inner winding side end part 40E1 to the outer winding side end part 40E2. Specifically, the inner side negative electrode active material layer 42B1 and the outer side negative electrode active material layer 42B2 include the same material, and the thickness T2 of the outer side negative electrode active material layer 42B2 is greater than the thickness T1 of the inner side negative electrode active material layer 42B1 over the region from the inner winding side end part 40E1 of the battery device 40 to the outer winding side end part 40E2 of the battery device 40. In other words, both the thickness T1 and the thickness T2 are each substantially constant in a longitudinal direction of the negative electrode 42 (i.e., in a winding direction of the battery device 40). In contrast, in the battery device 40A of the secondary battery according to the present embodiment illustrated in FIG. 8, the area density of the negative electrode active material layer 42B gradually changes from the inner winding side end part 40E1 toward the outer winding side end part 40E2. In the battery device 40A of the secondary battery according to the present embodiment, for example, the thickness T1 and the thickness T2 each gradually change. Note, however, that the area density of the outer side negative electrode active material layer 42B2 in the battery device 40A as a whole and the area density of the inner side negative electrode active material layer 42B1 in the battery device 40A as a whole are substantially equal to each other. In other words, in a case where the material included in the inner side negative electrode active material layer 42B1 and the material included in the outer side negative electrode active material layer 42B2 are substantially the same as each other, and where an occupation area of the inner side negative electrode active material layer 42B1 and an occupation area of the outer side negative electrode active material layer 42B2 are substantially equal to each other, a weight of the inner side negative electrode active material layer 42B1 and a weight of the outer side negative electrode active material layer 42B2 are substantially equal to each other. Note that a dashed line in FIG. 8 illustrates the inner side negative electrode active material layer 42B1 and the outer side negative electrode active material layer 42B2 when the thickness T1 and the thickness T2 are equal to each other.

Specifically, the area density of the outer side negative electrode active material layer 42B2 at the inner winding side end part 40E1 of the battery device 40A is higher than the area density of the outer side negative electrode active material layer 42B2 at the outer winding side end part 40E2 of the battery device 40A. More specifically, in an example of FIG. 8, the area density of the outer side negative electrode active material layer 42B2 is the highest at the inner winding side end part 40E1, and decreases from the inner winding side end part 40E1 toward the outer winding side end part 40E2. Even more specifically, the outer side negative electrode active material layer 42B2 includes a substantially homogeneous material, and the thickness T2 of the outer side negative electrode active material layer 42B2 is the greatest at the inner winding side end part 40E1, decreases from the inner winding side end part 40E1 toward the outer winding side end part 40E2, and is the smallest at the outer winding side end part 40E2. In other words, a relationship of T2S>T2E is satisfied, where T2S represents a thickness of the outer side negative electrode active material layer 42B2 at the inner winding side end part 40E1 and T2E represents a thickness of the outer side negative electrode active material layer 42B2 at the outer winding side end part 40E2.

In addition, in the secondary battery of the present embodiment, the area density of the inner side negative electrode active material layer 42B1 at the inner winding side end part 40E1 of the battery device 40A is lower than the area density of the inner side negative electrode active material layer 42B1 at the outer winding side end part 40E2 of the battery device 40A. More specifically, in the example of FIG. 8, the area density of the inner side negative electrode active material layer 42B1 is the lowest at the inner winding side end part 40E1, and increases from the inner winding side end part 40E1 toward the outer winding side end part 40E2. Even more specifically, the inner side negative electrode active material layer 42B1 includes a substantially homogeneous material, and the thickness T1 of the inner side negative electrode active material layer 42B1 is the smallest at the inner winding side end part 40E1, increases from the inner winding side end part 40E1 toward the outer winding side end part 40E2, and is the greatest at the outer winding side end part 40E2. In other words, a relationship of T1S<T1E is satisfied, where T1S represents a thickness of the inner side negative electrode active material layer 42B1 at the inner winding side end part 40E1 and TIE represents a thickness of the inner side negative electrode active material layer 42B1 at the outer winding side end part 40E2.

Except for those described above, a configuration of the secondary battery of the present embodiment is substantially the same as the configuration of the secondary battery of the above-described first embodiment.

An operation of the secondary battery of the present embodiment is the same as the operation of the secondary battery of the first embodiment.

A method of manufacturing the secondary battery of the present embodiment is the same as the method of manufacturing the secondary battery according to the first embodiment, except that the secondary battery of the present embodiment is fabricated such that the thickness T2 of the outer side negative electrode active material layer 42B2 and the thickness T1 of the inner side negative electrode active material layer 42B1 each gradually change over the region from the inner winding side end part 40E1 to the outer winding side end part 40E2.

As described above, according to the secondary battery of the present embodiment, the area density of the negative electrode active material layer 42B gradually changes from the inner winding side end part 40E1 toward the outer winding side end part 40E2. Specifically, the area density of the outer side negative electrode active material layer 42B2 at the inner winding side end part 40E1 of the battery device 40A is higher than the area density of the outer side negative electrode active material layer 42B2 at the outer winding side end part 40E2 of the battery device 40A. This allows, in terms of the relationship between the positive electrode 41 and the negative electrode 42 that are opposed to each other with the separator 43 interposed therebetween, the capacity of the negative electrode 42 to be greater than the capacity of the positive electrode 41, as with the secondary battery of the first embodiment. In other words, in terms of the relationship between the inner side positive electrode active material layer 41B1 and the outer side negative electrode active material layer 42B2 that are opposed to each other with the separator 43 interposed therebetween, it is possible to allow the capacity of the outer side negative electrode active material layer 42B2 to be greater than the capacity of the inner side positive electrode active material layer 41B1. As a result, it is possible for the secondary battery of the present embodiment to suppress the generation of the deposited matter such as lithium metal caused by the battery reaction upon charging, and to suppress a decrease in battery performance. Accordingly, the secondary battery achieves high reliability.

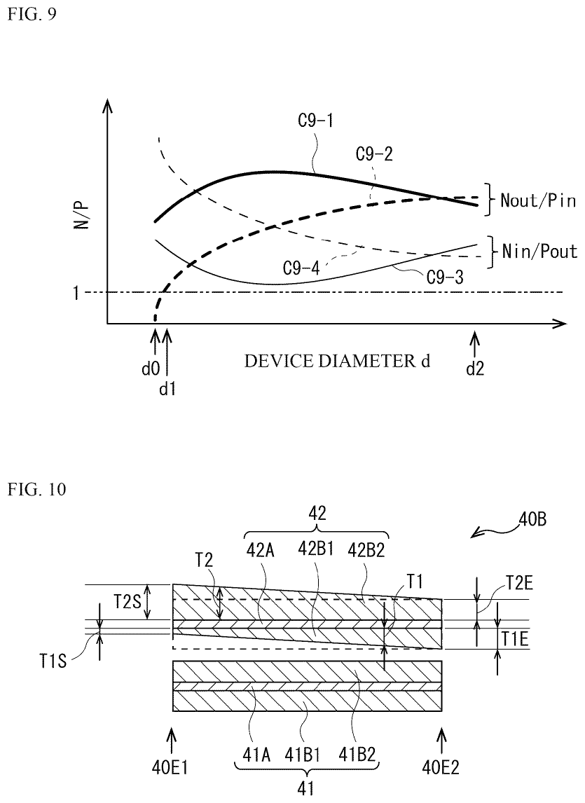

Action and effects of the secondary battery according to the present embodiment are described below in detail with reference to FIG. 9. FIG. 9 is an explanatory diagram illustrating a relationship between the capacity of the positive electrode 41 and the capacity of the negative electrode 42 in the battery device 40A of the present embodiment, and corresponds to FIG. 7 described in the first embodiment. A horizontal axis in FIG. 9 represents the device diameter d, and a vertical axis in FIG. 9 represents N/P as the ratio of the negative electrode capacity N to the positive electrode capacity P. What the device diameter d represents and what N/P represents in FIG. 9 are similar to those of FIG. 7. As illustrated in FIG. 9, N/P continuously changes depending on the dimension of the device diameter d. More specifically, out of four curves presented in FIG. 9, two curves C9-1 and C9-2 each represent Nout/Pin that is the ratio of the capacity of the outer side negative electrode active material layer 42B2 to the capacity of the inner side positive electrode active material layer 41B1. Out of the two curves C9-1 and C9-2, the curve C9-1 indicated by a solid line represents Nout/Pin of the secondary battery according to the present embodiment, and the curve C9-2 indicated by a dashed line represents Nout/Pin of the secondary battery according to the comparative example in which the area density of the outer side negative electrode active material layer 42B2 and the area density of the inner side negative electrode active material layer 42B1 are substantially equal to each other. Out of the four curves presented in FIG. 9, two curves C9-3 and C9-4 each represent Nin/Pout that is the ratio of the capacity of the inner side negative electrode active material layer 42B1 to the capacity of the outer side positive electrode active material layer 41B2. Out of the two curves C9-3 and C9-4, the curve C9-3 indicated by a solid line represents Nin/Pout of the secondary battery according to the present embodiment, and the curve C9-4 indicated by a dashed line represents Nin/Pout of the secondary battery according to the comparative example in which the area density of the outer side negative electrode active material layer 42B2 and the area density of the inner side negative electrode active material layer 42B1 are substantially equal to each other.

As is apparent from FIG. 9, it is possible for the secondary battery of the present embodiment to narrow a gap between Nout/Pin and Nin/Pout even in a region in which the device d is small, as compared with the comparative example. In other words, it is possible to suppress a fluctuation in a gap between the curve C9-1 and the curve C9-3 to be smaller than a fluctuation in a gap between the curve C9-2 and the curve C9-4 over a region from do to d2 in terms of the device diameter d. Accordingly, it is possible to achieve a favorable cyclability characteristic.

In contrast, in the secondary battery of the comparative example, the fluctuation in the gap between the curve C9-2 and the curve C9-4 over the region from do to d2 in terms of the device diameter d is large, which is disadvantageous for achieving a favorable cyclability characteristic. In addition, the secondary battery of the comparative example has Nout/Pin of less than 1 in the region in which the device diameter d is smaller than d1, as indicated by the curve C9-2. Accordingly, in the region in which the device diameter d is smaller than d1, the generation of the deposited matter such as lithium metal caused by the battery reaction easily occurs particularly when charging is performed at a high voltage, and a decrease in battery performance easily occurs. In order to avoid such generation of the deposited matter, it is desirable that in the secondary battery of the comparative example, the device diameter d of d1 be set to correspond to the inner winding side end part 40E1. As a result, however, the winding center space 40K of the battery device 40 has to be increased, which is disadvantageous for increasing a capacity.

In the secondary battery of the present embodiment, Nout/Pin and Nin/Pout are each greater than 1 regardless of the dimension of the device diameter d over the region from do to d2 in terms of the device diameter d (see the curve C9-1 and the curve C9-3). Accordingly, it is possible to set the device diameter d of d0 to correspond to the inner winding side end part 40E1, and to set the device diameter d of d2 to correspond to the outer winding side end part 40E2, which makes it possible to achieve the battery device 40 reduced in size of the winding center space 40K. As a result, the secondary battery of the present embodiment is advantageous for increasing the capacity.

Next, with reference to FIG. 10, a description is given of a secondary battery according to a third embodiment of the present disclosure. FIG. 10 is a developed diagram schematically illustrating the positive electrode 41 and the negative electrode 42 of a battery device 40B of the secondary battery according to the third embodiment of the present disclosure. FIG. 10 corresponds to FIG. 8 illustrating the developed diagram of the battery device 40A of the secondary battery according to the second embodiment described above.

In the battery device 40A of the secondary battery according to the second embodiment, the area density of the outer side negative electrode active material layer 42B2 in the battery device 40A as a whole and the area density of the inner side negative electrode active material layer 42B 1 in the battery device 40A as a whole are substantially equal to each other. In contrast, in the battery device 40B of the secondary battery according to the present embodiment illustrated in FIG. 10, the area density of the outer side negative electrode active material layer 42B2 in the battery device 40B as a whole is higher than the area density of the inner side negative electrode active material layer 42B 1 in the battery device 40B as a whole. Note that a dashed line in FIG. 10 illustrates the inner side negative electrode active material layer 42B1 and the outer side negative electrode active material layer 42B2 when the thickness T1 and the thickness T2 are equal to each other.

Except for those described above, a configuration of the secondary battery of the present embodiment is substantially the same as the configuration of the secondary battery of the above-described second embodiment.

An operation of the secondary battery of the present embodiment is the same as the operation of the secondary battery of the second embodiment.

A method of manufacturing the secondary battery of the present embodiment is the same as the method of manufacturing the secondary battery according to the second embodiment, except that the secondary battery of the present embodiment is fabricated such that the area density of the outer side negative electrode active material layer 42B2 in the battery device 40B as a whole is higher than the area density of the inner side negative electrode active material layer 42B1 in the battery device 40B as a whole.

As described above, according to the secondary battery of the present embodiment: the area density of the outer side negative electrode active material layer 42B2 in the battery device 40B as a whole is higher than the area density of the inner side negative electrode active material layer 42B1 in the battery device 40B as a whole; and the area density of the negative electrode active material layer 42B gradually changes from the inner winding side end part 40E1 toward the outer winding side end part 40E2. This allows, in terms of the relationship between the positive electrode 41 and the negative electrode 42 that are opposed to each other with the separator 43 interposed therebetween, the capacity of the negative electrode 42 to be greater than the capacity of the positive electrode 41, as with the secondary battery of the first embodiment. In other words, in terms of the relationship between the inner side positive electrode active material layer 41B1 and the outer side negative electrode active material layer 42B2 that are opposed to each other with the separator 43 interposed therebetween, it is possible to allow the capacity of the outer side negative electrode active material layer 42B2 to be greater than the capacity of the inner side positive electrode active material layer 41B1. As a result, it is possible for the secondary battery of the present embodiment to suppress the generation of the deposited matter such as lithium metal caused by the battery reaction upon charging, and to suppress a decrease in battery performance. Accordingly, the secondary battery achieves high reliability.

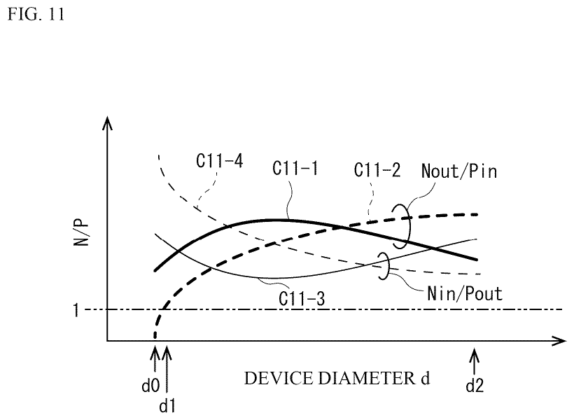

Action and effects of the secondary battery according to the present embodiment are described below in detail with reference to FIG. 11. FIG. 11 is an explanatory diagram illustrating a relationship between the capacity of the positive electrode 41 and the capacity of the negative electrode 42 in the battery device 40B of the present embodiment, and corresponds to FIG. 7 described in the first embodiment. A horizontal axis in FIG. 11 represents the device diameter d, and a vertical axis in FIG. 11 represents N/P as the ratio of the negative electrode capacity N to the positive electrode capacity P. What the device diameter d represents and what N/P represents in FIG. 11 are similar to those of FIG. 7. As illustrated in FIG. 11, N/P continuously changes depending on the dimension of the device diameter d. More specifically, out of four curves presented in FIG. 11, two curves C11-1 and C11-2 each represent Nout/Pin that is the ratio of the capacity of the outer side negative electrode active material layer 42B2 to the capacity of the inner side positive electrode active material layer 41B1. Out of the two curves C11-1 and C11-2, the curve C11-1 indicated by a solid line represents Nout/Pin of the secondary battery according to the present embodiment, and the curve C11-2 indicated by a dashed line represents Nout/Pin of the secondary battery according to the comparative example in which the area density of the outer side negative electrode active material layer 42B2 and the area density of the inner side negative electrode active material layer 42B1 are substantially equal to each other. Out of the four curves presented in FIG. 11, two curves C11-3 and C11-4 each represent Nin/Pout that is the ratio of the capacity of the inner side negative electrode active material layer 42B1 to the capacity of the outer side positive electrode active material layer 41B2. Out of the two curves C11-3 and C11-4, the curve C11-3 indicated by a solid line represents Nin/Pout of the secondary battery according to the present embodiment, and the curve C11-4 indicated by a dashed line represents Nin/Pout of the secondary battery according to the comparative example in which the area density of the outer side negative electrode active material layer 42B2 and the area density of the inner side negative electrode active material layer 42B1 are substantially equal to each other.

As is apparent from FIG. 11, it is possible for the secondary battery of the present embodiment to narrow a gap between Nout/Pin and Nin/Pout even in a region in which the device d is small, as compared with the comparative example. In other words: it is possible to suppress a fluctuation in a gap between the curve C11-1 and the curve C11-3 to be smaller than a fluctuation in a gap between the curve C11-2 and the curve C11-4 over the region from do to d2 in terms of the device diameter d; and it is also possible to suppress the fluctuation in the gap between the curve C11-1 and the curve C11-3 to be smaller than the fluctuation in the gap between the curve C9-1 and the curve C9-3 described above in the second embodiment over the region from do to d2 in terms of the device diameter d. Accordingly, it is possible to achieve a cyclability characteristic that is more favorable than that of the secondary battery of the second embodiment.

In the secondary battery of the present embodiment also, Nout/Pin and Nin/Pout are each greater than 1 regardless of the dimension of the device diameter d over the region from do to d2 in terms of the device diameter d (see the curve C11-1 and the curve C11-3). Accordingly, it is possible to set the device diameter d of d0 to correspond to the inner winding side end part 40E1, and to set the device diameter d of d2 to correspond to the outer winding side end part 40E2, which makes it possible to achieve the battery device 40 reduced in size of the winding center space 40K. As a result, the secondary battery of the present embodiment is advantageous for increasing the capacity.

### 4. EXAMPLES

A description is given of Examples of the present disclosure according to an embodiment.

### Example 1

The secondary battery (the lithium-ion secondary battery) illustrated in FIGS. 1 to 5 was fabricated. Specifically, the secondary battery of the coin type was fabricated. In the secondary battery of the coin type, the area density of the outer side negative electrode active material layer 42B2 was higher than the area density of the inner side negative electrode active material layer 42B1 over the region from the inner winding side end part 40E1 of the battery device 40 to the outer winding side end part 40E2 of the battery device 40.

### [Fabrication of Positive Electrode]

First, 91 parts by mass of a positive electrode active material (LiCoO₂), 3 parts by mass of a positive electrode binder (polyvinylidene difluoride), and 6 parts by mass of a positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on the two opposed surfaces of the positive electrode current collector 41A (a band-shaped aluminum foil having a thickness of 12 μm) by a coating apparatus, following which the applied positive electrode mixture slurry was dried to thereby form the positive electrode active material layers 41B. Lastly, the positive electrode active material layers 41B were compression-molded by a roll pressing machine. In this manner, the positive electrode 41 (having a width of 3.3 mm) was fabricated. Note that the thickness of the inner side positive electrode active material layer 41B1 and the thickness of the outer side positive electrode active material layer 41B2 after the compression molding were each set to 0.037 mm.

### [Fabrication of Negative Electrode]

First, 95 parts by mass of a negative electrode active material (graphite) and 5 parts by mass of a negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on the two opposed surfaces of the negative electrode current collector 42A (a band-shaped copper foil having a thickness of 15 μm) by a coating apparatus, following which the applied negative electrode mixture slurry was dried to thereby form the negative electrode active material layers 42B. Lastly, the negative electrode active material layers 42B were compression-molded by a roll pressing machine. In this manner, the negative electrode 42 (having a width of 3.8 mm) was fabricated. At this time, the inner side negative electrode active material layer 42B1 and the outer side negative electrode active material layer 42B2 were so formed that the thickness T1 of the inner side negative electrode active material layer 42B1 and the thickness T2 of the outer side negative electrode active material layer 42B2 were each constant, and that the thickness T2 of the outer side negative electrode active material layer 42B2 was greater than the thickness T1 of the inner side negative electrode active material layer 42B1. Specifically, the thickness T1 after the compression molding was set to 0.046 mm and the thickness T2 after the compression molding was set to 0.049 mm. In other words, the area density of the outer side negative electrode active material layer 42B2 and the area density of the inner side negative electrode active material layer 42B1 were set to be different from each other. Specifically, where an average area density of the outer side negative electrode active material layer 42B2 and the inner side negative electrode active material layer 42B1 in the battery device 40 as a whole was set to 100%, the area density of the outer side negative electrode active material layer 42B2 in the battery device 40 as a whole was set to 101.8% and the area density of the inner side negative electrode active material layer 42B1 in the battery device 40 as a whole was set to 98.2%. Note that, in Examples, the area density of the outer side negative electrode active material layer 42B2 and the area density of the inner side negative electrode active material layer 42B1 each had no gradient in the longitudinal direction of the negative electrode 42, and were each substantially constant.

### [Preparation of Electrolytic Solution]

An electrolyte salt (LiPF₆) was added to a solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. As a result, the electrolytic solution was prepared.

### [Assembly of Secondary Battery]

First, the positive electrode lead 51 including aluminum was welded to the positive electrode 41 (the positive electrode current collector 41A) by the resistance welding method. The positive electrode lead 51 had a thickness of 0.1 mm, a width of 2.0 mm, and a protruding length of 11.7 mm from the positive electrode 41, and was partially covered at the periphery thereof by the sealant 61 having a tubular shape. The sealant 61 was a polypropylene film and had an outer diameter of 9.0 mm and an inner diameter of 3.0 mm. Further, the negative electrode lead 52 including nickel was welded to the negative electrode 42 (the negative electrode current collector 42A) by the resistance welding method. The negative electrode lead 52 had a thickness of 0.1 mm, a width of 2.0 mm, and a protruding length of 6.0 mm from the negative electrode 42. In this case, a welding position of the positive electrode lead 51 was so adjusted that the welding position of the positive electrode lead 51 was in the middle of winding of the positive electrode 41.

Thereafter, the positive electrode 41 and the negative electrode 42 were stacked on each other with the separator 43 interposed therebetween. The separator 43 was a fine-porous polyethylene film having a thickness of 25 μm and a width of 4.0 mm. Thereafter, the stack of the positive electrode 41, the negative electrode 42, and the separator 43 was wound to thereby fabricate the wound body 40Z having a cylindrical shape. The wound body 40Z had an outer diameter of 11.6 mm. The wound body 40Z had the winding center space 40K. The winding center space 40K had an inner diameter of 1.5 mm.

Thereafter, a ring-shaped insulating film for underlayment was placed into the container part 11 through the opening 11K. The ring-shaped insulating film was a polyimide film and had an outer diameter of 11.6 mm, an inner diameter of 2.2 mm, and a thickness of 0.05 mm. The container part 11 had a cylindrical shape and included stainless steel (SUS316). The container part 11 had a wall thickness of 0.15 mm, an outer diameter of 12.0 mm, and a height of 5.0 mm. Thereafter, the wound body 40Z was placed inside the container part 11. In this case, the negative electrode lead 52 was welded to the container part 11 by the resistance welding method. Thereafter, the positive electrode lead 51 was welded to the external terminal 20 of the cover part 12 by the resistance welding method. The cover part 12 had a disk shape and included stainless steel (SUS316). The cover part 12 had a wall thickness of 0.15 mm and an outer diameter of 11.7 mm. The cover part 12 had the recessed part 12H having an inner diameter of 9.0 mm and a height of a stepped part of 0.3 mm. The recessed part 12H had the through hole 12K having an inner diameter of 3.0 mm. The cover part 12 also had the external terminal 20 attached thereto with the gasket 30 interposed therebetween. The external terminal 20 had a disk shape and included aluminum. The external terminal 20 had a wall thickness of 0.3 mm and an outer diameter of 7.2 mm. The gasket 30 was a polyimide film and had an outer diameter of 9.2 mm and an inner diameter of 3.2 mm.

Thereafter, the electrolytic solution was injected into the container part 11 through the opening 11K in a state where the cover part 12 was raised relative to the container part 11. Thus, the wound body 40Z (including the positive electrode 41, the negative electrode 42, and the separator 43) was impregnated with the electrolytic solution, and the battery device 40 was fabricated.

Lastly, the opening 11K was closed with use of the cover part 12, following which the cover part 12 was welded to the container part 11 by the laser welding method. When the opening 11K was closed by the cover part 12, the turning part 513 was so formed in a portion of the positive electrode lead 51 as to form a curved shape, and was so formed as to be positioned in the peripheral part 12R. Specifically, adjustment was performed such that a distance between the turning part 513 and an inner surface of the sidewall part M3 became 0.5 mm. In addition, the insulating film 62 having a ring shape was disposed between the cover part 12 and the positive electrode lead 51, and the insulating film 63 having a disk shape was disposed between the battery device 40 and the positive electrode lead 51. The insulating film 62 was a polyimide film and had an outer diameter of 9.2 mm and an inner diameter of 3.2 mm. The insulating film 63 was a polyimide film and had an outer diameter of 3.2 mm. Thus, the outer package can 10 was formed with use of the container part 11 and the cover part 12, and the battery device 40 was sealed in the outer package can 10. As a result, the secondary battery was assembled. The secondary battery had an outer diameter of 12.0 mm and a height of 5.0 mm.

### [Stabilization of Secondary Battery]

The assembled secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours.

As a result, a film was formed on a surface of, for example, the negative electrode 42. This brought the secondary battery into an electrochemically stable state. The secondary battery was thus completed.

Next, secondary batteries fabricated as described above were each evaluated for performance. The results are presented in Table 1.

### [Table 1]

TABLE 1

| | | | | | | Com- | Com- | Com- |
|---|---|---|---|---|---|---|---|---|
| | | | | | | parative | parative | parative |
| | Example 1 | Example 2 | Example 3 | Example 4 | Example 5 | example 1 | example 2 | example 3 |
| Inner diameter | 1.5 | 1.5 | 1.0 | 1.0 | 1.0 | 1.0 | 4.0 | 1.0 |
| of battery | | | | | | | | |
| device [mm] | | | | | | | | |
| Difference | ±1.8% | ±1.8% | ±1.8% | ±1.8% | ±1.8% | None | None | None |
| between area | | | | | | | | |
| densities of | | | | | | | | |
| negative | | | | | | | | |
| electrode active | | | | | | | | |
| material layers | | | | | | | | |
| Gradient in area | None | None | None | None | −6% to | None | None | None |
| densities of | | | | | +6% | | | |
| negative | | | | | | | | |
| electrode active | | | | | | | | |
| material layers | | | | | | | | |
| Charge voltage | 4.38 | 4.45 | 4.38 | 4.45 | 4.45 | 4.38 | 4.45 | 4.45 |
| [V] | | | | | | | | |
| Minimum | 75 | 20 | 66 | 17 | 20 | 18 | 20 | 15 |
| negative | | | | | | | | |
| electrode | | | | | | | | |
| potential | | | | | | | | |
| (d < 4 mm) | | | | | | | | |
| [mV] | | | | | | | | |
| Minimum | 72 | 19 | 66 | 19 | 19 | 87 | 70 | 70 |
| negative | | | | | | | | |
| electrode | | | | | | | | |
| potential | | | | | | | | |
| (d ≥ 4 mm) | | | | | | | | |
| [mV] | | | | | | | | |
| Discharge | 90 | 97 | 90 | 97 | 97 | 90 | 83 | 97 |
| capacity | | | | | | | | |
| [mAh] | | | | | | | | |
| Energy density | 6.5 | 17.1 | 6.8 | 17.4 | 17.4 | 6.8 | 0.0 | 17.4 |
| increase rate | | | | | | | | |
| [%] | | | | | | | | |
| Cycle capacity | 92 | 82 | 90 | 60 | 83 | 65 | 85 | 52 |
| retention rate | | | | | | | | |
| [%] | | | | | | | | |

Here, measured were: a minimum negative electrode potential (d<4 mm) [mV] in a region of the battery device 40, in which the device diameter d was less than 4 mm; a minimum negative electrode potential (d≥4 mm) [mV] in a region, of the battery device 40, in which the device diameter d was greater than or equal to 4 mm; a discharge capacity [mAh]; an energy density increase rate [%]; and a cycle capacity retention rate [%].

For the discharge capacity [mAh], a discharge test was performed under the following test conditions, and the discharge capacity [mAh] was measured. The test conditions of the discharge test were as follows.

### [Discharge Test Conditions]

(1) Temperature of environment in which test was performed: 23° C.
(2) Charging condition: Constant-current constant-voltage (CC-CV) charging was performed. The secondary battery was charged with a constant current of 0.5 C until a voltage reached 4.38 V, and was thereafter charged with a constant voltage of 4.38 V. A cut-off current was set to 0.025 C.
(3) Rest time after charging: 30 minutes
(4) Discharging condition: Constant-current (CC) discharging was performed with a constant current of 0.5 C. A cut-off voltage was set to 3.0 V.

The cycle capacity retention rate [%] was determined by performing a charging and discharging cycle test according to the following test conditions.

In the charging and discharging cycle test, first, the secondary battery was charged and discharged in an ambient temperature environment (at a temperature of 25° C.) to thereby measure a discharge capacity (a first-cycle discharge capacity). Thereafter, the secondary battery was repeatedly charged and discharged in the same environment until the total number of cycles reached 501 to thereby measure the discharge capacity (a 501st-cycle discharge capacity). Lastly, the following was calculated: capacity retention rate (%)=(501st-cycle discharge capacity/first-cycle discharge capacity)×100.

In the charging and discharging cycle test, upon charging, the secondary battery was charged with a constant current of 2 C until a battery voltage reached 4.38 V, and was thereafter charged with a constant voltage of 4.38 V until a current reached 0.025 C. Upon discharging, the secondary battery was discharged with a constant current of 0.7 C until the battery voltage reached 3.0 V. Note that 2 C was a value of a current that caused the battery capacity (the theoretical capacity) to be completely discharged in 0.5 hours, and 0.7 C was a value of a current that caused the battery capacity to be completely discharged in 1.43 hours.

The minimum negative electrode potential (d<4 mm) [mV] was an open circuit potential (versus a lithium reference electrode) of the negative electrode 42 measured in the region, of the battery device 40 of the secondary battery in a fully charged state, in which the device diameter d was less than 4 mm.

The minimum negative electrode potential (d≥4 mm) [mV] was an open circuit potential (versus a lithium reference electrode) of the negative electrode 42 measured in the region, of the battery device 40 of the secondary battery in the fully charged state, in which the device diameter d was greater than or equal to 4 mm.

The discharge capacity was acquired by the discharge test based on the discharge test conditions described above. Based on the assumption that a volume of the secondary battery is constant, a capacity increase rate based on a discharge capacity of Comparative example 2 to be described later as a reference was determined as the energy density increase rate [%].

### Example 2

A secondary battery of Example 2 was fabricated in a manner similar to that in Example 1. Note, however, that the battery voltage (a charge voltage) upon charging in the charging and discharging cycle test was set to 4.45 V. Except for this difference, the secondary battery of Example 2 was subjected to evaluation similar to that to which the secondary battery of Example 1 was subjected. The results are also presented in Table 1.

### Example 3

The inner diameter of the winding center space 40K was set to 1.0 mm. Except for this difference, a secondary battery of Example 3 was fabricated in a manner similar to that in which the secondary battery of Example 1 was fabricated, and was subjected to evaluation similar to that to which the secondary battery of Example 1 was subjected. The results are also presented in Table 1.

### Example 4

A secondary battery of Example 4 was fabricated in a manner similar to that in Example 3. Note, however, that the battery voltage (the charge voltage) upon charging in the charging and discharging cycle test was set to 4.45 V. Except for this difference, the secondary battery of Example 4 was subjected to evaluation similar to that to which the secondary battery of Example 1 was subjected. The results are also presented in Table 1.

### Example 5

The inner diameter of the winding center space 40K was set to 1.0 mm. Further, as with the battery device 40B illustrated in FIG. 10: the thickness T1 of the inner side negative electrode active material layer 42B1 was gradually increased from the inner winding side end part 40E1 toward the outer winding side end part 40E2; and the thickness T2 of the outer side negative electrode active material layer 42B2 was gradually decreased from the inner winding side end part 40E1 toward the outer winding side end part 40E2. In addition, the battery voltage (the charge voltage) upon charging in the charging and discharging cycle test was set to 4.45 V. Except for these differences, a secondary battery of Example 5 was fabricated in a manner similar to that in Example 1, and was subjected to evaluation similar to that to which the secondary battery of Example 1 was subjected. The results are also presented in Table 1. In this case, where an average value of the thickness T1 was set to 100%, a minimum value of the thickness T1 was set to 94% and a maximum value of the thickness T1 was set to 106%. Similarly, where an average value of the thickness T2 was set to 100%, a minimum value of the thickness T2 was set to 94% and a maximum value of the thickness T2 was set to 106%.

### Comparative Example 1

The inner diameter of the winding center space 40K was set to 1.0 mm. Further, the thickness T1 of the inner side negative electrode active material layer 42B1 and the thickness T2 of the outer side negative electrode active material layer 42B2 were each set to 0.047 mm. Except for these differences, a secondary battery of Comparative example 1 was fabricated in a manner similar to that in which the secondary battery of Example 1 was fabricated, and was subjected to evaluation similar to that to which the secondary battery of Example 1 was subjected. The results are also presented in Table 1.

### Comparative Example 2

A secondary battery of Comparative example 2 was fabricated in a manner similar to that of the secondary battery of Example 1 except that the inner diameter of the winding center space 40K was set to 4.0 mm. Further, the battery voltage (the charge voltage) upon charging in the charging and discharging cycle test was set to 4.45 V. Except for these differences, the secondary battery of Comparative example 2 was subjected to evaluation similar to that to which the secondary battery of Comparative example 1 was subjected. The results are also presented in Table 1.

### Comparative Example 3

A secondary battery of Comparative example 3 was fabricated in a manner similar to that in Comparative example 1. Note, however, that the battery voltage (the charge voltage) upon charging in the charging and discharging cycle test was set to 4.45 V. Except for this difference, the secondary battery of Comparative example 3 was subjected to evaluation similar to that to which the secondary battery of Comparative example 1 was subjected. The results are also presented in Table 1.

As indicated in Table 1, it was found that in each of Example 1 and Example 3 in which the charge voltage was set to 4.38 V, the cycle capacity retention rate greatly improved as compared with Comparative example 1 in which the charge voltage was also set to 4.38 V. One reason for this is that: in Comparative example 1, the minimum negative electrode potential in the region in which the device diameter d was less than 4 mm greatly decreased as compared with the minimum negative electrode potential in the region in which the device diameter d was greater than or equal to 4 mm; whereas in each of Example 1 and Example 3, a decrease in the minimum negative electrode potential in the region in which the device diameter d was less than 4 mm did not occur. In other words, it is conceivable that in each of Example 1 and Example 3, it was possible to allow the capacity of the outer side negative electrode active material layer 42B2 to be greater than the capacity of the inner side positive electrode active material layer 41B1 even in the region, of the battery device 40, in which the device diameter d was less than 4 mm.

It was found that in each of Example 2, Example 4, and Example 5 in which the charge voltage was set to 4.45 V, the cycle capacity retention rate improved as compared with Comparative example 3 in which the charge voltage was also set to 4.45 V. One reason for this is that: in Comparative example 3, the minimum negative electrode potential in the region in which the device diameter d was less than 4 mm greatly decreased as compared with the minimum negative electrode potential in the region in which the device diameter d was greater than or equal to 4 mm; whereas in each of Example 2, Example 4, and Example 5, a decrease in the minimum negative electrode potential in the region in which the device diameter d was less than 4 mm did not occur. Note that in Comparative example 2 in which the charge voltage was also set to 4.45 V, the inner diameter of the winding center space 40K was set to 4.0 mm, which avoided deterioration of the cycle capacity retention rate. However, in Comparative example 2, the discharge capacity was small as compared with Example 2, Example 4, Example 5, and Comparative example 3.

Further, based on comparison between Example 4 and Example 5, it was confirmed that it was possible to improve the cycle capacity retention rate even more when: the area density of the outer side negative electrode active material layer 42B2 was higher than the area density of the inner side negative electrode active material layer 42B1 over the region from the inner winding side end part 40E1 to the outer winding side end part 40E2; and the area density of the outer side negative electrode active material layer 42B2 and the area density of the inner side negative electrode active material layer 42B 1 each gradually changed from the inner winding side end part 40E1 toward the outer winding side end part 40E2.

Although the present technology has been described above with reference to one or more embodiments including Examples, the configuration of the present technology is not limited thereto, and is therefore modifiable in a variety of ways.

Although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed between the container part and the cover part.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are merely examples, and the effects of the present disclosure are not limited to those described herein. Accordingly, the present disclosure may achieve other effects.

In addition, the present disclosure may encompass the following embodiments.

<1>

A secondary battery including:
a battery device including a first electrode and a second electrode that are stacked with a separator interposed between the first electrode and the second electrode, and are wound around a winding axis extending in a first direction; and
an outer package member that contains the battery device, in which
the second electrode includes a second electrode current collector, an inner side second electrode active material layer, and an outer side second electrode active material layer, the second electrode current collector having an inward second electrode surface and an outward second electrode surface, the inward second electrode surface facing a side of the winding axis, the outward second electrode surface being on an opposite side to the inward second electrode surface, the inner side second electrode active material layer being provided on the inward second electrode surface, the outer side second electrode active material layer being provided on the outward second electrode surface, and
an area density of the outer side second electrode active material layer is higher than an area density of the inner side second electrode active material layer over a region from an inner winding side end part of the battery device to an outer winding side end part of the battery device, the inner side second electrode active material layer being opposed to the outer side second electrode active material layer with the second electrode current collector interposed between the inner side second electrode active material layer and the outer side second electrode active material layer.
   <2>

The secondary battery according to <1>, in which the area density of the outer side second electrode active material layer at the inner winding side end part of the battery device is higher than the area density of the outer side second electrode active material layer at the outer winding side end part of the battery device.

<3>

The secondary battery according to <1> or <2>, in which the area density of the outer side second electrode active material layer is highest at the inner winding side end part of the battery device, and decreases from the inner winding side end part of the battery device toward the outer winding side end part of the battery device.

<4>

The secondary battery according to any one of <1> to <3>, in which a thickness of the outer side second electrode active material layer is greatest at the inner winding side end part of the battery device, and decreases from the inner winding side end part of the battery device toward the outer winding side end part of the battery device.

<5>

The secondary battery according to any one of <1> to <4>, in which the area density of the inner side second electrode active material layer at the inner winding side end part of the battery device is lower than the area density of the inner side second electrode active material layer at the outer winding side end part of the battery device.

<6>

The secondary battery according to any one of <1> to <5>, in which the area density of the inner side second electrode active material layer is lowest at the inner winding side end part of the battery device, and increases from the inner winding side end part of the battery device toward the outer winding side end part of the battery device.

<7>

The secondary battery according to any one of <1> to <6>, in which a thickness of the inner side second electrode active material layer is smallest at the inner winding side end part of the battery device, and increases from the inner winding side end part of the battery device toward the outer winding side end part of the battery device.

<8>

A secondary battery including:
a battery device including a first electrode and a second electrode that are stacked with a separator interposed between the first electrode and the second electrode, and are wound around a winding axis extending in a first direction; and
an outer package member that contains the battery device, in which
the second electrode includes a second electrode current collector, an inner side second electrode active material layer, and an outer side second electrode active material layer, the second electrode current collector having an inward second electrode surface and an outward second electrode surface, the inward second electrode surface facing a side of the winding axis, the outward second electrode surface being on an opposite side to the inward second electrode surface, the inner side second electrode active material layer being provided on the inward second electrode surface, the outer side second electrode active material layer being provided on the outward second electrode surface,
an area density of the outer side second electrode active material layer is highest at an inner winding side end part of the battery device, and decreases from the inner winding side end part of the battery device toward an outer winding side end part of the battery device, and
an area density of the inner side second electrode active material layer is lowest at the inner winding side end part of the battery device, and increases from the inner winding side end part of the battery device toward the outer winding side end part of the battery device.
   <9>

The secondary battery according to <8>, in which a thickness of the outer side second electrode active material layer is greatest at the inner winding side end part of the battery device, and decreases from the inner winding side end part of the battery device toward the outer winding side end part of the battery device.

<10>

The secondary battery according to <8> or <9>, in which a thickness of the inner side second electrode active material layer is smallest at the inner winding side end part of the battery device, and increases from the inner winding side end part of the battery device toward the outer winding side end part of the battery device.

<11>

The secondary battery according to any one of <1> to <10>, in which the first electrode includes a positive electrode, and the second electrode includes a negative electrode.

<12>

The secondary battery according to any one of <1> to <11>, in which an outer diameter of the outer package member in a second direction is greater than a height of the outer package member in the first direction, the second direction being orthogonal to the first direction.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device including a first electrode and a second electrode that are stacked with a separator interposed between the first electrode and the second electrode, and are wound around a winding axis extending in a first direction; and
an outer package member that contains the battery device, wherein
the second electrode includes a second electrode current collector, an inner side second electrode active material layer, and an outer side second electrode active material layer, the second electrode current collector having an inward second electrode surface and an outward second electrode surface, the inward second electrode surface facing a side of the winding axis, the outward second electrode surface being on an opposite side to the inward second electrode surface, the inner side second electrode active material layer being provided on the inward second electrode surface, the outer side second electrode active material layer being provided on the outward second electrode surface, and
an area density of the outer side second electrode active material layer is higher than an area density of the inner side second electrode active material layer over a region from an inner winding side end part of the battery device to an outer winding side end part of the battery device, the inner side second electrode active material layer being opposed to the outer side second electrode active material layer with the second electrode current collector interposed between the inner side second electrode active material layer and the outer side second electrode active material layer.

2. The secondary battery according to claim 1, wherein the area density of the outer side second electrode active material layer at the inner winding side end part of the battery device is higher than the area density of the outer side second electrode active material layer at the outer winding side end part of the battery device.

3. The secondary battery according to claim 1, wherein the area density of the outer side second electrode active material layer is highest at the inner winding side end part of the battery device, and decreases from the inner winding side end part of the battery device toward the outer winding side end part of the battery device.

4. The secondary battery according to claim 1, wherein a thickness of the outer side second electrode active material layer is greatest at the inner winding side end part of the battery device, and decreases from the inner winding side end part of the battery device toward the outer winding side end part of the battery device.

5. The secondary battery according to claim 1, wherein the area density of the inner side second electrode active material layer at the inner winding side end part of the battery device is lower than the area density of the inner side second electrode active material layer at the outer winding side end part of the battery device.

6. The secondary battery according to claim 1, wherein the area density of the inner side second electrode active material layer is lowest at the inner winding side end part of the battery device, and increases from the inner winding side end part of the battery device toward the outer winding side end part of the battery device.

7. The secondary battery according to claim 1, wherein a thickness of the inner side second electrode active material layer is smallest at the inner winding side end part of the battery device, and increases from the inner winding side end part of the battery device toward the outer winding side end part of the battery device.

8. A secondary battery comprising:
a battery device including a first electrode and a second electrode that are stacked with a separator interposed between the first electrode and the second electrode, and are wound around a winding axis extending in a first direction; and
an outer package member that contains the battery device, wherein
the second electrode includes a second electrode current collector, an inner side second electrode active material layer, and an outer side second electrode active material layer, the second electrode current collector having an inward second electrode surface and an outward second electrode surface, the inward second electrode surface facing a side of the winding axis, the outward second electrode surface being on an opposite side to the inward second electrode surface, the inner side second electrode active material layer being provided on the inward second electrode surface, the outer side second electrode active material layer being provided on the outward second electrode surface,
an area density of the outer side second electrode active material layer is highest at an inner winding side end part of the battery device, and decreases from the inner winding side end part of the battery device toward an outer winding side end part of the battery device, and
an area density of the inner side second electrode active material layer is lowest at the inner winding side end part of the battery device, and increases from the inner winding side end part of the battery device toward the outer winding side end part of the battery device.

9. The secondary battery according to claim 8, wherein a thickness of the outer side second electrode active material layer is greatest at the inner winding side end part of the battery device, and decreases from the inner winding side end part of the battery device toward the outer winding side end part of the battery device.

10. The secondary battery according to claim 8, wherein a thickness of the inner side second electrode active material layer is smallest at the inner winding side end part of the battery device, and increases from the inner winding side end part of the battery device toward the outer winding side end part of the battery device.

11. The secondary battery according to claim 1, wherein the first electrode comprises a positive electrode, and the second electrode comprises a negative electrode.

12. The secondary battery according to claim 1, wherein an outer diameter of the outer package member in a second direction is greater than a height of the outer package member in the first direction, the second direction being orthogonal to the first direction.
